(19) United States
(12) Patent Application Publication
(10) Pub. No.: US 2006/0179240 A1
(43) Pub. Date: Aug. 10, 2006

(54) System and method for algorithmic cache-bypass

(75) Inventors: Siddhartha Chatterjee, Yorktown Heights, NY (US); John A. Gunnels, Brewster, NY (US); Fred Gehrung Gustavson, Briarcliff Manor, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/052,877

(22) Filed: Feb. 9, 2005

(51) Int. Cl. G06F 13/28

(52) U.S. Cl. 711/138

(57) ABSTRACT

A system for (and method of) algorithmic cache-bypass which includes acting on at least one level of cache to at least one of bypass the at least one level of cache, stream through the at least one level of cache, force utilization of at least one other level of cache, bypass at least one level of cache, bypass all levels of cache, force utilization of a main memory, and force utilization of an out-of core memory.

### STATEMENT REGARDING FEDERALLY SPONSORED RESEARCH OR DEVELOPMENT

This invention was made with Government support under Contract No.: B517552 awarded by the Department of Energy. The Government has certain rights in this invention.

### BACKGROUND OF THE INVENTION

1. Field of the Invention

The present invention generally relates to a system and method for accessing data, or for organizing the loops for a routine (e.g., a standard routine such as matrix multiplication), in a way that is sub-optimal for a number of lower levels of cache (e.g., L1, L2, . . . etc. cache) in order to act on (e.g., overwhelm, etc.) the lower level of cache and cause the use of a higher level of cache or main memory.

2. Description of the Related Art

Particularly in newer computing architectures (e.g., parallel computing system architectures), the lower levels of memory evidence shortcomings (which are generally unavoidable, for example, as a result of design decisions based on cost) that are not encountered in or have a less severe impact in the higher levels of memory (e.g., lower associativity, non-LRU replacement strategies). Further, this method allows one to take advantage of hardware prefetching, which tends to require “missing” in the lower levels of cache.

The related art solutions attempt (1) to take as much advantage of the lower level cache as possible (i.e., work around the weak point), (2) to simply target a higher level of cache and ignore the weak spot, or (3) only use prefetching during the phases when the lower level of cache's data needs to be replaced and accepting the latency “hit” at the beginning of each such phase.

The first related art solution does not work well, however, because by assumption, the targeted level of cache is not well-constructed for the operation under consideration. On the other hand, the second related art solution ignores a flaw in the design and ignoring such flaws will inevitably lead to unexpectedly poor performance for some problem instances, because the implications of the feature/shortcoming are not focused upon. The third related art solution shares the weakness of the first and as the “memory wall” problem becomes greater, the loss of performance due to latency penalties will become greater.

Further, it may be necessary to carefully orchestrate memory access in order to deal with a limited number of outstanding cache misses being allowed by the architecture or when exploiting the LI-register interface to its fullest. This is problematic because it imposes considerable extra complexity on the programmer or compiler because, by assumption, the lower level of cache does not act in a well-behaved (LRU) manner. By enabling the user or compiler to target the higher level of cache this orchestration becomes simpler for the user or the compiler to implement.

The related art methods have not addressed or solved the aforementioned problems.

### SUMMARY OF THE INVENTION

In view of the foregoing, and other, exemplary problems, drawbacks, and disadvantages of the conventional systems and methods, an exemplary feature of the present invention provides a method and system which addresses and solves the aforementioned problems, among others.

The unique and unobvious features of the present invention are directed to a novel system and method for organizing code (e.g., the loops for a routine, for example, a standard routine such as matrix multiplication) in a way that is sub-optimal for a number of lower, and presumably smaller, levels of cache (e.g., L1 cache) in order to act on (e.g., overwhelm, etc.) the lower levels of cache and cause the use of a higher level of cache, thereby allowing simpler coding and performance analysis as well as superior performance characteristics. This method is also simple enough to be captured by and implemented in modern compiler technology, allowing the user to utilize the method without intimate knowledge of it.

According to the exemplary aspects of the present invention, it can be beneficial to access memory in such a way so as to make the lower levels of cache behave in a manner that would be considered sub-optimal for the lower levels of cache in order for code targeted at a higher level to behave optimally and to utilize the hardware prefetch mechanism common in today's machines.

According to the exemplary aspects of the invention, by accessing the data in such a way so as to make certain that if the sum of the sizes of the objects involved in an algorithm is big enough to be ejected from lower levels of cache (e.g., the L1 cache), they will be so ejected.

Thus, one can target their code at a higher level (or levels) of cache (e.g., the more well-behaved L2, L3, . . . etc., or a higher level or levels of cache) of a computing system architecture, such as a parallel computing system architecture, as well as other architectures) without experiencing the performance “blips” (reloading the lower level of cache, latency induced by the breaking of prefetch streams, etc.) that will occur if one were to process them in the normal/traditional way. Here, the round-robin cache is problematic to analyze and problematic from a cache-touch orchestration perspective, but it is still straightforward to determine how much data (e.g., sequential data) needs to go through a cache in order to verify that the next access (e.g., within the aforementioned sequential data block) will result in a cache miss.

In one illustrative, non-limiting aspect of the invention, an exemplary method of algorithmic cache-bypass includes acting on (e.g., overwhelming, etc.) a first level (or levels) of cache to bypass the first level (or levels) of cache, stream through the first level (or levels) of cache, force utilization of a second level (or levels) of cache, bypass all levels of cache, force utilization of a main memory, and/or force utilization of an out-of core memory.

The first level (or levels) of cache can include a lower level of cache or a higher level of cache. On the other hand, the second level (or levels) of cache can include the other of the lower level of cache or the higher level of cache. The lower level of cache can include a smaller cache than the higher level of cache.

In one exemplary aspect of the invention, the first level (or levels) of cache can be acted on (e.g., overwhelmed, etc.) by organizing a routine (e.g., a matrix multiplication routine, etc.) in such a way as to act on (e.g., overwhelm, etc.) the first level (or levels) of cache and cause the bypassing of the first level (or levels) of cache, the streaming through of the first level (or levels) of cache, the utilization of the second level (or levels) of cache, the bypassing of all levels of cache, the utilization of a main memory, and/or the utilization of an out-of core memory. The routine can be invoked when it is determined that the first level or levels (e.g., lower level or levels) of cache, used as designed, will not result in processing the data at a predetermined optimal level.

In another exemplary aspect of the invention, the first level (or levels) of cache can be acted on (e.g., overwhelmed, etc.) by accessing data such that a sum of sizes of objects involved in an algorithm can result in ejection of the objects from the first level (or levels) of cache, injection of the objects into the second level (or levels) of cache, bypassing of the first level (or levels) of cache by the objects, streaming the objects through the first level (or levels) of cache, bypassing of all levels of cache by the objects, the injecting of the objects into the main memory, and the injecting of the objects into the out-of core memory.

In one exemplary aspect of the invention, the step of accessing data includes determining whether the sum of the sizes of the objects involved in the algorithm is equal to or greater than a predetermined amount which can result in the ejection of the objects from the first level (or levels) of cache, the injection of the objects into the second level (or levels) of cache, the objects bypassing the first level (or levels) of cache, the objects streaming through the first level (or levels) of cache, the objects bypassing all levels of cache, the injection of the objects into the main memory, and the injection of the objects into the out-of core memory.

The first level (or levels) of cache can be acted on (e.g., overwhelmed, etc.) by determining how much data of a data block needs to pass through the at least one of the first level of cache to ensure that an access within the data block will result in a cache miss of the at least one of the first level of cache. Such data can include sequential data, etc., and such data block (or blocks) can include a sequential data block (or blocks), etc.

In other exemplary aspects of the invention, the first level (or levels) of cache can be acted on (e.g., overwhelmed, etc.) by accessing memory to make the first level (or levels) of cache behave in a predetermined sub-optimal manner such that code targeted at the second level (or levels) of cache behaves in a predetermined optimal manner. In other words, the notion is that the result is globally optimal or closer to globally optimal despite the fact that the lowest level of cache may not be used in a manner that allows it to sustain locally optimal performance at any point in time (e.g., the standard method would have it evince locally closer to optimal, then very suboptimal performance in a sort of “spikey” fashion).

The exemplary methods also can determine an order in which processes (e.g., multiplications of matrices, etc.) are performed which provides at least one of a maximal distance between accesses to the at least on of the first level of cache and a maximal eviction rate from the at least one of the first level of cache.

For example, matrix multiplication routine can include, among other things, multiplying a first matrix, which includes a predetermined number of rows, by a second matrix, which includes a predetermined number of columns, to obtain a third matrix. Thus, according to one exemplary aspect of the invention, an access to an element of the first matrix or the second matrix occurs after all of either the first matrix or the second matrix has been pulled through the first level of cache or the second level of cache.

According to an exemplary aspect of the invention, substantially all of the smaller of the first and second matrices is put through the first level (or levels) of cache or the second level (or levels) of cache each time between accesses to an element of the first or second matrix.

In yet another exemplary aspect of the invention, a method of algorithmic cache-bypass includes controlling access to a level (or levels) of cache. When the level (or levels) of cache is acted on (e.g., overwhelmed, etc.) either the level (or levels) of cache is bypassed, the level (or levels) of cache is streamed through, all levels of cache are bypassed, another level (or levels) of cache is utilized, a main memory is utilized, and/or an out-of-core memory is utilized.

As in the previously described aspects of the invention, the above described exemplary method can act on (e.g., overwhelm, etc.) the level (or levels) of cache by accessing data such that a size of the at least one level of cache is less than a sum of a size of operands involved in an algorithm, or by organizing a routine (e.g., a matrix multiplication routine or routines, etc.) in such a way as to act on (e.g., overwhelm, etc.) the level (or levels) of cache, etc. The level (or levels) of cache can include either a lower level of cache or a higher level of cache.

In yet another exemplary aspect of the invention, a system for algorithmic cache-bypass includes at least one level of cache and means for controlling access to the level (or levels) of cache, wherein, when the level (or levels) of cache is acted on (e.g., overwhelmed, etc.) then the level (or levels) of cache is bypassed, the level (or levels) of cache is streamed through, all levels of cache are bypassed, at least one other level (or levels) of cache is utilized, a main memory is utilized, and/or an out-of-core memory is utilized. The level (or levels) of cache is acted on (e.g., overwhelmed, etc.) when a size of the at least one cache is less than a sum of a size of operands involved in an algorithm.

In another exemplary aspect of the invention, a system for algorithmic cache-bypass includes at least one level (or levels) of cache and a controlling unit that controls access to the level (or levels) of cache, wherein, when the level (or levels) of cache is acted on (e.g., overwhelmed, etc.), then the level (or levels) of cache is bypassed, the level (or levels) of cache is streamed through, all levels of cache are bypassed, another level (or levels) of cache is utilized, a main memory is utilized, and/or an out-of-core memory is utilized.

In still another exemplary aspect of the invention, a signal-bearing medium tangibly embodying a program of machine-readable instructions executable by a digital processing apparatus performs the exemplary methods for algorithmic cache-bypass, according to the present invention.

The present invention, as exemplarily described above, allows simpler coding and performance analysis as well as superior performance characteristics. The present invention also is simple enough (and inexpensive enough, in terms of memory and other hardware) to be captured by and implemented in modem compiler technology, allowing the user to utilize the method without intimate knowledge of it.

According to the exemplary aspects of the present invention, it can be beneficial to access memory in such a way so as to make the lower levels of cache (e.g., smaller levels of cache, etc.) behave in a manner that would be considered sub-optimal for the lower levels of cache in order for code targeted at a higher level (e.g., larger levels of cache, etc.) to behave optimally and to utilize the hardware prefetch mechanism common in today's machines (e.g., computing systems such as parallel computing systems).

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates C=C+/−A*B (matrices) according to an exemplary method 100 of the present invention;

FIG. 2 illustrates how values of C=C+/−A*B (matrices) are calculated according to the exemplary method 100 of the present invention;

FIG. 3 illustrates how the order in which C=C+/−A*B is calculated according to the exemplary method 100 of the present invention;

FIG. 4 illustrates the numbered pairs of jumps in the C=C+/−A*B (matrices) according to the exemplary method 100 of the present invention;

FIG. 5 illustrates an exemplary hardware/information handling system 500 for incorporating the present invention therein; and

FIG. 6 illustrates a signal bearing medium 600 (e.g., storage medium) for storing steps of a program of a method according to the present invention.

### DETAILED DESCRIPTION OF EXEMPLARY EMBODIMENTS OF THE INVENTION

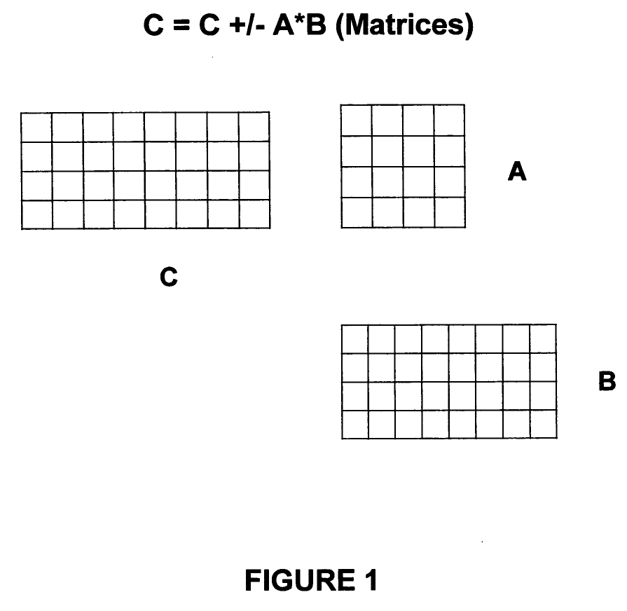

Referring now to the drawings, and more particularly to FIGS. 1-4, there are shown exemplary embodiments of the method and systems according to the present invention.

As described above, the related art solutions do not work well, for example, because by assumption, the targeted level of cache is not well-constructed for the operation under consideration, or alternatively, because the related art solutions ignore a flaw in the design and ignoring such flaws will inevitably lead to unexpectedly poor performance for some problem instances, because the implications of the feature/shortcoming are not focused upon. And because such solutions often tend to fail to take advantage of other hardware features, such as hardware prefetching, by necessity as such prefetching typically requires cache misses.

On the other hand, it may be necessary to carefully orchestrate memory access in order to deal with a limited number of outstanding cache misses being allowed by the architecture or when exploiting the L1-register interface to its fullest, which also is not desirable because of the difficulty involved in orchestrating for a cache level that is not LRU. Usually this cache uses a round-robin replacement which is difficult to model for this sort of orchestration. The related art methods do not address or solve the aforementioned problems.

Referring to FIGS. 1-4, the present invention has discovered that it can be beneficial to access memory in such a way so as to make the lower level of cache behave in a manner that would be considered sub-optimal in order for code targeted at a higher level of cache to behave optimally. In the exemplary method 100 illustrated in FIGS. 1-4, the cache feature overcome is a round-robin replacement policy in the L1 cache (e.g., part of a core, for example, which can be used in a parallel computing system).

The present invention also makes analysis of algorithms more practical since modeling a non-LRU (i.e., non-least recently used) cache is problematic, but modeling a “non-cache” is quite simple (e.g., if one assumes that L1 is treated as described herein and L2 is a LRU (i.e., least recently used), then one need only model L2 and above).

Turning to FIGS. 1-4, the present invention generally relates to a novel system and method of accessing data, or organizing a loop for a routine (e.g., a standard routine such as matrix multiplication), in a way that is sub-optimal for a lower level of cache (e.g., L1 cache) in order to act on (e.g., overwhelm, etc.) the lower level of cache and cause the use of a higher level of cache.

According to the exemplary aspects of the invention, by accessing the data in such a way so as to make certain that if the sum of the sizes of the objects involved in an algorithm is big enough to be ejected from a lower level of cache (e.g., the L1 cache), they will be so ejected.

Thus, one can target their code at a higher level of cache (e.g., the more well-behaved L2 cache, L3 cache, . . . etc., or the next higher level of cache or other memory, such as main memory or out-of-core memory, etc., of a computing system architecture, such as a parallel computing system architecture, as well as other architectures) without experiencing the performance “blips” that will occur if one were to process them in the normal way. Here, the round-robin cache is problematic to analyze and problematic from a cache-touch orchestration perspective, but it is still straightforward to determine how much data (e.g., sequential data) needs to go through a cache in order to verify that the next access (e.g., within the aforementioned sequential data block) will result in a cache miss.

As discussed above, by organizing the loops for such standard routines as matrix multiplication in a way that appears completely sub-optimal for one level of cache, here L1, one can act on (e.g., overwhelm, etc.) a lower level of cache and use a higher level of cache. This allows simpler coding and performance analysis, a greater utilization of the hardware prefetch mechanisms, as well as the superior performance that is the main target of such work.

Referring to FIGS. 1-4, in an exemplary method 100 according to the present invention, matrix A includes rows a, b, c, d, . . . . On the other hand, matrix B includes columns 1, 2, 3, 4, . . . . Further, matrix C is the result of C+/−A*B. That is, C=C+/−A*B (matrices).

According to the exemplary method of the present invention, the order in which multiplications are done is very simple. If the number of rows (or blocks of rows . . . as this is often implemented as part of a blocked algorithm) of A and the number of (perhaps blocks) of columns of B are relatively prime, the (i, j) target of C (which totally determines the rows/columns of A/B to be accessed are rotated through on a simple schedule).

Row i = random ( )// the starting point does not matter
Column j = random ( ) // ditto
For i = 1 to the number of rows*number of columns

{
C(i,j) = C(i,j) +/− A(i)*B(j); // standard kernel
1 = (i + 1)% number of rows of A;

j = (j + 1) % number of columns of B;
}

This ensures maximal distance between accesses and maximal eviction rates from the lowest level of cache, as any access to an element of A or B will occur after the entire A (or B) matrix has been pulled through the cache.

If the two values are not relatively prime, then there are two alternatives according to this exemplary aspect of the invention: 1) do the largest subsection of C that results in relative primeness; or 2) select one of the matrices (the larger one) and force a shift when the access to that matrix wraps.

For example, for i=1 to number of rows * number of columns // where each “row” is actually a set of rows (blocked in some sense, likely register blocked):

{
C(i,j) = C(i,j) +/− A(i)*B(j); // standard kernel
i = (i + j) % number of rows of A; //suppose that columns > rows here
j = (j + 1) % number of columns of B;
if (i == 0)

then j = (j + 1) % number of columns of B;

}

Here, the exemplary solution (2) may be more straightforward and loses no “data throughput” (what the present invention is attempting to maximize) for the smaller matrix. Also, assuming that the exemplary operation of the present invention is matrix multiplication and the desire is to bypass, for example, the L1 cache (e.g., Examining register blocking):

0) Let our register blocking be T (on many machines, 4 is a reasonably acceptable or good block size; e.g., see FIG. 1-4)
1) A(m×k) * B(k*n)=>C(m*n)and
2) The number of block columns, Q, is i*P(P==number of block rows) [P*T=m, Q*T=n]
3) We use the same register blocking strategy on A, B, and C (square blocking).

It is noted that this exemplary method works with non-square blocking as well (e.g., see FIGS. 1-4).

In the exemplary method, P*T*K elements of A (i.e., all of the A operand) are accessed before the same element of A is accessed again.

Also, at least (Q−Ceil[Q/P])*T*k elements of B are accessed before the same element of B is accessed again.

Thus, this stage of the exemplary method is only Ceil[Q/P]*T*k elements away from putting all of A and all of B though the cache between accesses.

According to the exemplary aspects of the invention, selecting block sizes to yield either relatively prime (e.g., blocked) matrix dimensions or dimensions simply large enough to wash out the cache even with this slight lessening of throughput are easily done.

Finally, it is the smaller matrix that will be the limiting factor here and, by construction, the entire small matrix is put through the cache each time between element accesses.

As mentioned above, FIGS. 1-4 illustrate another exemplary aspect of the invention. Specifically, FIGS. 1-4 illustrate how C=C+/−A*B is calculated.

In FIGS. 1-4, rows of A * columns of B=>blocks of C. Therefore, only rows of A/ columns of B are numbered. On the other hand, all blocks of C are marked as row/column intersections.

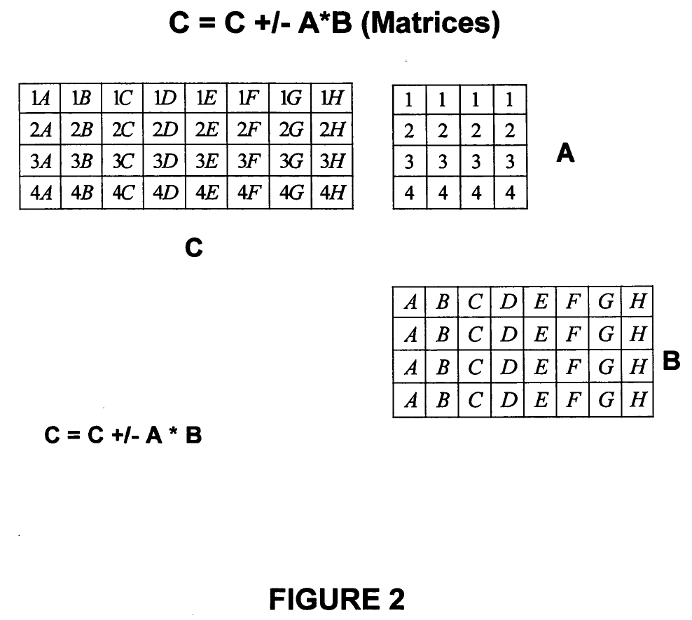

Turning to FIG. 2, with respect to the definitions of the terms, ‘S’, ‘T’, and ‘U’ are register-block sizes, in which register block multiplication of S×T * T×U=>S×U.

‘A’ is defined m×k (e.g., m/S blocks×k/T blocks). ‘B’ is defined as k×n (e.g., k/T blocks×n/U blocks). ‘C’ is defined as m×n (e.g., m/S blocks×n U blocks). For simplification, in the form description, it can be assumed that T=S=U.

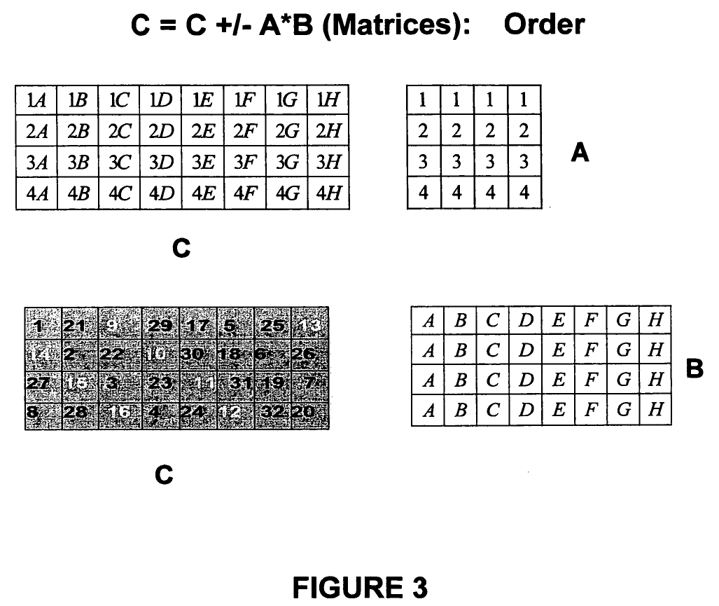

Turning to FIG. 3, the order in which C=C+/−A*B is calculated will be explained.

As with FIG. 2, in FIG. 3, rows of A * columns of B =>blocks of C. Therefore, the C order is indicated (e.g., it dictates access in others).

Since rows (A)/columns (B) are not relatively prime, then:
Row value=1,2,3,4,1,2,3,4,. . . Column Index Jumps.

Column value=1,2,3,4, jump ,6,7,8,1 ,jump,3,. . . Row Index Jumps.

Here, the # rows<the# cols . . . former (Column Index Jumps).

It is noted that an analogous process can be performed if the number of columns is less than the number of rows.

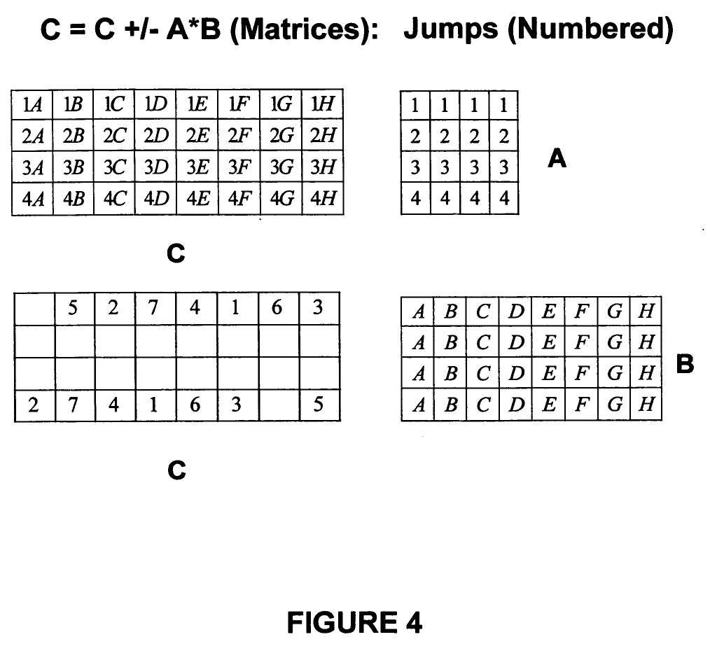

Referring to FIG. 4, FIG. 4 illustrates the pairs of jumps (e.g., pairs 1-7) indicated in FIG. 3.

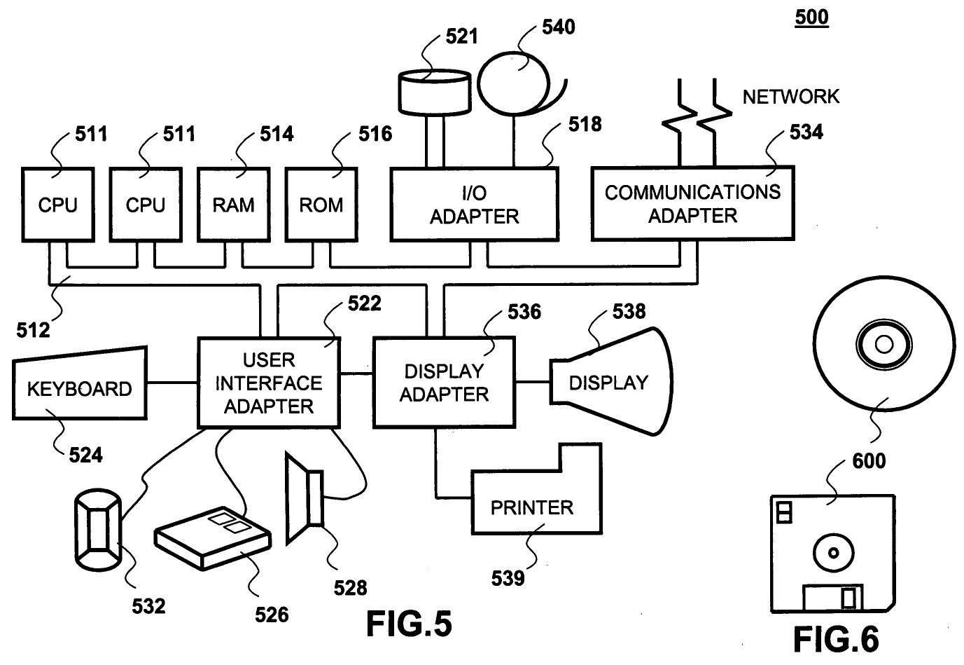

FIG. 5 illustrates an exemplary hardware/information handling system 500 for incorporating the present invention therein; and FIG. 6 illustrates a signal bearing medium 600 (e.g., storage medium) for storing steps of a program of a method according to the present invention.

FIG. 5 illustrates a typical hardware configuration of an information handling/computer system for use with the invention and which preferably has at least one processor or central processing unit (CPU) 511.

The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communication adapter 534 for connecting an information handling system to a data processing network, the Internet, an Intranet, a personal area network (PAN), etc., and a display adapter 536 for connecting the bus 512 to a display device 538 and/or printer.

In addition to the hardware/software environment described above, a different aspect of the invention includes a computer-implemented method of performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 511, as represented by the fast-access storage for example. Alternatively, the instructions may be contained in another signal-bearing media, such as a magnetic data storage diskette 600 (FIG. 6), directly or indirectly accessible by the CPU 511.

Whether contained in the diskette 600, the computer/CPU 511, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

Thus, the illustrative, non-limiting embodiments of the present invention as described above, overcome the problems of the conventional methods and systems.

As described above, the unique and unobvious features of the present invention are directed to a novel system and method for accessing data, or organizing a loop for a routine (e.g., a standard routine such as matrix multiplication, etc.), in a way that is sub-optimal for a lower level (or levels) of cache (e.g., L1 cache) in order to act on (e.g., overwhelm, etc.) the lower, and presumably smaller, level (or levels) of cache and cause the use of a higher level (or levels) of cache.

According to the exemplary aspects of the invention, by accessing the data in such a way so as to make certain that if the sum of the sizes of the objects involved in an algorithm is big enough to be ejected from a lower level (or levels) of cache (e.g., the L1 cache), they will be so ejected.

Thus, one can target their code at a higher level (or levels) of cache (e.g., the more well-behaved L3/L2 cache, etc., or a next higher level of cache, main memory, or out-of-core memory, etc., of a computing system architecture, such as a parallel computing system architecture, as well as other architectures) without experiencing the performance “blips” that will occur if one were to process them in the normal way. Here, the round-robin cache is problematic to analyze and problematic from a cache-touch orchestration perspective, but it is still straightforward to determine how much data (e.g., sequential data) needs to go through a cache in order to verify that the next access (e.g., within the aforementioned sequential data block) will result in a cache miss.

As discussed above, by organizing the loops for such standard routines as matrix multiplication in a way that appears completely sub-optimal for one level of cache, here L1, one can act on (e.g., overwhelm, etc.) a lower level of cache and use a higher level of cache. This allows simpler coding and performance analysis as well as the superior performance that is the main target of such work.

While the invention has been described in terms of several preferred embodiments, those skilled in the art will recognize that the invention can be practiced with modification within the spirit and scope of the appended claims.

Further, it is noted that, the inventors' intent is to encompass equivalents of all claim elements, even if amended later during prosecution.

What is claimed is:

1. A method of algorithmic cache-bypass, comprising:
acting on at least one of a first level of cache to at least one of bypass the at least one of said first level of cache, stream through the at least one of said first level of cache, force utilization of at least one of a second level of cache, bypass at least one level of cache, bypass all levels of cache, force utilization of a main memory, and force utilization of an out-of core memory.

2. The method of algorithmic cache-bypass according to claim 1, wherein said first level of cache comprises:
at least one of a lower level of cache and a higher level of cache.

3. The method of algorithmic cache-bypass according to claim 2, wherein said second level of cache comprises:
at least one of the other of said lower level of cache and said higher level of cache.

4. The method of algorithmic cache-bypass according to claim 2, wherein said lower level of cache comprises:
a smaller cache than said higher level of cache.

5. The method of algorithmic cache-bypass according to claim 1, wherein said acting on the at least one of said first level of cache, comprises:
organizing a routine in such a way as to act on the at least one of said first level of cache and cause at least one of the bypassing of the at least one of said first level of cache, the streaming through of the at least one of said first level of cache, the utilization of the at least one of said second level of cache, the bypassing of at least one level of cache, the bypassing of all levels of cache, the utilization of a main memory, and the utilization of an out-of core memory.

6. The method of algorithmic cache-bypass according to claim 5, wherein said routine comprises:
a matrix multiplication routine.

7. The method of algorithmic cache-bypass according to claim 5, wherein said organizing comprises:
organizing said routine so that the at least one of said first level of cache cannot process said routine at a predetermined optimal level.

8. The method of algorithmic cache-bypass according to claim 1, wherein said acting on the at least one of said first level of cache, comprises:
accessing data such that a sum of sizes of objects involved in an algorithm can result in at least one of ejection of said objects from the at least one of said first level of cache, injection of said objects into the at least one of said second level of cache, bypassing of the at least one of said first level of cache by said objects, streaming said objects through the at least one of said first level of cache, bypassing of at least one level of cache by said objects, bypassing of all levels of cache by said objects, the injecting of said objects into the main memory, and the injecting of said objects into the out-of core memory.

9. The method of algorithmic cache-bypass according to claim 8, further comprising:
at least one of ejecting said objects from the at least one of said first level of cache, injecting said objects into the at least one of said second level of cache, bypassing the at least one of said first level of cache by said objects, streaming said objects through the at least one of said first level of cache, bypassing at least one level of cache by said objects, bypassing of all levels of cache by said objects, injecting said objects into the main memory, and injecting said objects into the out-of core memory.

10. The method of algorithmic cache-bypass according to claim 8, wherein said accessing data further comprises:
determining whether said sum of the sizes of the objects involved in said algorithm is equal to or greater than a predetermined amount which can result in at least one of the ejection of said objects from the at least one of said first level of cache, the injection of said objects into the at least one of said second level of cache, the objects bypassing the at least one of said first level of cache, the objects streaming through the at least one of said first level of cache, the objects bypassing at least one level of cache, the objects bypassing all levels of cache, the injection of said objects into the main memory, and the injection of said objects into the out-of core memory.

11. The method of algorithmic cache-bypass according to claim 1, wherein said acting on the at least one of said first level of cache, comprises:
determining how much data of a data block needs to pass through the at least one of said first level of cache to ensure that an access within the data block will result in a cache miss of the at least one of said first level of cache.

12. The method of algorithmic cache-bypass according to claim 10, wherein said data comprises:
sequential data.

13. The method of algorithmic cache-bypass according to claim 10, wherein said data block comprises:
a sequential data block.

14. The method of algorithmic cache-bypass according to claim 1, wherein said acting on the at least one of said first level of cache, comprises:
accessing memory to make the at least one of said first level of cache behave in a predetermined sub-optimal manner such that code targeted at the at least one of said second level of cache behaves in a predetermined optimal manner.

15. The method of algorithmic cache-bypass according to claim 5, further comprising:
determining an order in which processes are performed which provides at least one of a maximal distance between accesses to the at least on of said first level of cache and a maximal eviction rate from the at least one of said first level of cache.

16. The method of algorithmic cache-bypass according to claim 6, further comprising:
determining an order in which multiplications of matrices are performed which provides at least one of a maximal distance between accesses to the at least one of said first level of cache and a maximal eviction rate from the at least one of said first level of cache.

17. The method of algorithmic cache-bypass according to claim 6, wherein said matrix multiplication routine comprises:
multiplying a first matrix, which includes a predetermined number of rows, by a second matrix, which includes a predetermined number of columns, to obtain a third matrix;
wherein an access to an element of one of the first matrix and the second matrix occurs after all of said one of the first matrix and the second matrix has been pulled through at least one of said first level of cache and said second level of cache.

18. The method of algorithmic cache-bypass according to claim 6, wherein said matrix multiplication routine comprises:
multiplying a first matrix, which includes a predetermined number of rows, by a second matrix, which includes a predetermined number of columns, to obtain a third matrix;
wherein substantially all of a smaller of said first matrix and said second matrix is put through at least one of the first level of cache and the second level of cache each time between accesses to an element of one of the first matrix and the second matrix.

19. The method of algorithmic cache-bypass according to claim 1, wherein said acting on the at least one of said first level of cache comprises:
overwhelming the at least one of said first level of cache.

20. A method of algorithmic cache-bypass, comprising:
controlling access to at least one level of cache,
wherein, when the at least one level of cache is acted on, at least one of the at least one level of cache is bypassed, the at least one level of cache is streamed through, all levels of cache are bypassed, at least one other level of cache is utilized, a main memory is utilized, and an out-of-core memory is utilized.

21. The method of algorithmic cache-bypass according to claim 20, wherein said acting on the at least one level of cache, comprises:
accessing data such that a size of the at least one level of cache is less than a sum of a size of operands involved in an algorithm.

22. The method of algorithmic cache-bypass according to claim 20, wherein the at least one level of cache comprises:
one of a lower level of cache and a higher level of cache.

23. The method of algorithmic cache-bypass according to claim 22, wherein said other level of cache comprises:
the other of said lower level of cache and said higher level of cache.

24. The method of algorithmic cache-bypass according to claim 20, wherein said controlling comprises:
organizing a routine in such a way as to act on the at least one level of cache.

25. The method of algorithmic cache-bypass according to claim 24, wherein said routine comprises:
a matrix multiplication routine.

26. The method of algorithmic cache-bypass according to claim 20, wherein said acting on the at least one level of cache comprises:
overwhelming the at least one level of cache.

27. A system for algorithmic cache-bypass, the system comprising:
at least one level of cache; and
means for controlling access to the at least one level of cache,
wherein, when the at least one level of cache is acted on, then at least one of the at least one level of cache is bypassed, the at least one level of cache is streamed through, all levels of cache are bypassed, at least one other level of cache is utilized, a main memory is utilized, and an out-of-core memory is utilized.

28. The system for algorithmic cache-bypass according to claim 27, wherein the at least one level of cache is acted on when a size of the at least one cache is less than a sum of a size of operands involved in an algorithm.

29. The method of algorithmic cache-bypass according to claim 27, wherein said acting on the at least one level of cache comprises:
overwhelming the at least one level of cache.

30. A system for algorithmic cache-bypass, the system comprising:
at least one level of cache; and
a controlling unit that controls access to at least one of said first level of cache and a second level of cache,
wherein, when the at least one level of cache is acted on, then at least one of the at least one level of cache is bypassed, the at least one level of cache is streamed through, all levels of cache are bypassed, at least one other level of cache is utilized, a main memory is utilized, and an out-of-core memory is utilized.

31. The system according to claim 30, wherein the at least one level of cache is acted on when a size of the at least one cache is less than a sum of a size of operands involved in an algorithm.

32. The method of algorithmic cache-bypass according to claim 30, wherein said acting on the at least one level of cache comprises:
overwhelming the at least one level of cache.

33. A signal-bearing medium tangibly embodying a program of machine-readable instructions executable by a digital processing apparatus to perform a method of algorithmic cache-bypass, the method comprising:
acting on at least one of a first level of cache to at least one of bypass the at least one of said first level of cache, stream through the at least one of said first level of cache, force utilization of at least one of a second level of cache, bypass all levels of cache, force utilization of a main memory, and force utilization of an out-of core memory.
